(19) United States
(12) Patent Application Publication
(10) Pub. No.: US 2025/0077389 A1
(43) Pub. Date: Mar. 6, 2025

(54) METHOD FOR PREDICTING THE PERFORMANCE OF A SOFTWARE PROGRAM

(71) Applicants: Dakshina Narahari Dasari, Renningen (DE); Anthony Rowe, Pittsburgh, PA (US); Arjun Ramesh, Pittsburgh, PA (US); Michael Pressler, Karlsruhe (DE); Nuno Pereira, Pittsburgh, PA (US); Tianshu Huang, Pittsburgh, PA (US)

(72) Inventors: Dakshina Narahari Dasari, Renningen (DE); Anthony Rowe, Pittsburgh, PA (US); Arjun Ramesh, Pittsburgh, PA (US); Michael Pressler, Karlsruhe (DE); Nuno Pereira, Pittsburgh, PA (US); Tianshu Huang, Pittsburgh, PA (US)

(21) Appl. No.: 18/822,521

(22) Filed: Sep. 3, 2024

(30) Foreign Application Priority Data
Sep. 6, 2023 (DE) 10 2023 208 598.4

(51) Int. Cl. G06F 11/36

(52) U.S. Cl. CPC G06F 11/3612

(57) ABSTRACT

A method for predicting the performance of a software program. The method includes: profiling the software program in a bytecode representation thereof, wherein the profiling is performed during the execution of the software program, in order to provide an execution property of the software program; profiling a runtime on a target device, wherein the profiling is performed while executing at least one test program on the runtime of the target device, in order to provide a runtime property of the target device; predicting the performance of an execution of the software program on the target device based on the execution property of the software program and the runtime property of the target device. A computer program, an apparatus, and a storage medium are also described.

### CROSS REFERENCE

The present application claims the benefit under 35 U.S.C. § 119 of German Patent Application No. DE 10 2023 208 598.4 filed on Sep. 6, 2023, which is expressly incorporated herein by reference in its entirety.

### FIELD

The present invention relates to a method for predicting the performance of a software program. Furthermore, the present invention relates to a computer program, an apparatus and a storage medium therefor.

### BACKGROUND INFORMATION

Predicting the performance of software components when being executed on different platforms can be challenging due to differences in compiler optimizations, operating system (OS) performance and computer hardware architecture. This performance uncertainty can be exacerbated by collision with other tasks and a workload on this system, causing additional input/output (I/O), and memory determinism. The performance prediction usually refers to the execution time, but can also comprise energy consumption, memory usage or network usage. Known solutions to this problem can comprise measuring worst-case performance, binary analysis, source code analysis, and pre-benchmarking for similar targets while simultaneously recording performance events. In addition, newer approaches are exploring in particular techniques which are based on machine learning and bring together as much information as possible about a platform and various features of the tested software. In the examples above, features can either be analyzed statically through source or binary code analysis, or metrics can be measured at runtime in a compiled target.

In bytecode analysis, a static analysis of the raw bytecode, i.e. the intermediate code format, of a program can be used to predict its execution time. However, this static analysis can be difficult to perform, since it can be difficult to know which parts of the bytecode are executed at execution time and with what frequency.

Alternatively, dynamic analysis can be used to detect streams of bytecode instructions and memory access patterns on a target processor as they are executed. This can be difficult to accomplish on hardware that runs in real time without significantly impacting program operation, which in turn can negatively impact the accuracy of predictions. Finally, any analysis of raw bytecode can be negatively affected by the fact that different hardware platforms might have different bytecode instruction sets, making comparisons between different platforms difficult.

With source code analysis, the static analysis of the source code of a software program can be used in order to predict its execution time. The source code can be inherently cross-platform and can be very useful for static analysis. However, source code analysis might require a different analysis system for each programming language used, which makes supporting multiple programming languages difficult and time-consuming. Source code analysis can also suffer from the general difficulty of static analysis of knowing which code path to take during execution.

When profiling performance events, dynamic profiling, which considers hardware performance events during execution, can be used to predict performance on a different target. In order to minimize intrusiveness and not negatively impact the execution of the program, these hardware performance events may not be as comprehensive or invasive as bytecode analysis. Therefore, profiling with performance events may not be able to detect all features of the program, which limits the potential accuracy of the prediction algorithm.

### SUMMARY

According to aspects of the present invention, a method, a computer program, a data processing apparatus, and a computer-readable storage medium are provided. Features and details of the present invention are disclosed herein. Features and details described in the context of the method according to the present invention also correspond in each case to the computer program according to the present invention, the data processing apparatus according to the present invention and the computer-readable storage medium according to the present invention, and vice versa.

According to one aspect of the present invention, a method for predicting the performance of a software program is provided.

According to an example embodiment of the present invention, the method comprises the following steps:
profiling the software program, wherein the software program is provided as a bytecode representation, wherein the profiling is performed during the execution of the software program, in order to provide an execution property of the software program,
profiling a runtime on a target device, wherein the profiling is performed while executing at least one test program on the runtime of the target device, in order to provide a runtime property of the target device,
predicting the performance of an execution of the software program on the target device based on the execution property of the software program and the runtime property of the target device.

In other words, profiling the software program can be understood as the analysis of the behavior of the software program during its execution. Profiling the runtime on the target device can be understood as the analysis of the behavior and technical properties of the target device, such as performance in terms of its execution time. The term “target device” can also be referred to or understood as “target hardware.” In general, profiling of the software program and the runtime on the target device can be performed in order to gain findings with respect to performance and efficiency, function calls, memory usage and access, thread behavior and/or input/output operations. Simply put, according to one example of the invention, the profiling of the software program can indicate which bytecode operations are executed by the software program, and the profiling of the runtime on the target device can indicate how long such bytecode operations take on the target device in each case, or how much power is consumed, or how much memory is used. The performance forecast can therefore also comprise energy consumption, storage usage or network usage. The method according to the invention can be advantageous in a cloud computing environment, particularly in cloud deployment, due to the fact that different software programs and different target devices can be profiled, such that performance can be more accurately predicted for different pairings of software programs and target devices. The invention can also be advantageous in a context in which the performance of a software program needs to be predicted when it is moved from one platform to another.

According to an example embodiment of the present invention, it can be advantageous if the method further comprises at least one of the following steps:
compiling the software program into the bytecode representation,
compiling the bytecode representation as a pre-compilation, in order to make the bytecode representation executable on the target device.

Compiling the bytecode representation as a pre-compilation can have the advantage of higher performance, better predictability of the behavior and performance of the software program, and lower resource usage, compared to just-in-time compilation.

According to an example embodiment of the present invention, it is possible that the bytecode representation comprises at least one bytecode instruction and the profiling of the software program further comprises the following step:
executing the at least one bytecode instruction at a point in time in order to analyze and describe the bytecode representation at least in terms of a frequency of the at least one bytecode instruction and a pattern of memory accesses of the at least one bytecode instruction, in order to provide the execution property of the software program.

The pattern of memory accesses can, for example, be a periodic pattern, a sporadic pattern or a burst pattern. It can also be provided that a frequency of individual memory accesses is analyzed and described.

In another example embodiment of the present invention, the analyzing and describing of the bytecode representation are performed based on bytecode operation code sequences of the bytecode instructions, wherein an estimated execution frequency and an estimated pattern of memory accesses are provided for each bytecode operation code sequence. The operation code can be a part of a machine language instruction that specifies an operation to be performed by the CPU of a computer. A bytecode operation code sequence can refer to a series of such operations, i.e. a sequence of operation codes that the CPU executes in order. In general, operation code sequences can be the result of compiling a higher-level program into machine code, or be part of the bytecode that a virtual machine or interpreter executes.

In another example embodiment of the present invention, the prediction of the performance comprises a prediction of at least one of the following:
an execution time of the execution of the software program on the target device,
an energy consumption of the execution of the software program on the target device,
a memory usage of the execution of the software program on the target device,
a network usage of the execution of the software program on the target device.

According to an example embodiment of the present invention, it is possible that the execution of the software program is predicted for different inputs for each of the preceding aspects. Predicting not only the execution time, but a plurality of or all of the above aspects can be advantageous in that it provides a more detailed and differentiated analysis of the execution of the software program on the target hardware.

According to an example embodiment of the present invention, it is also possible that the profiling of the runtime on the target device comprises the following steps:
detecting data about an execution of the at least one test program during its execution, wherein the data comprise sections of different instruction patterns of the at least one test program,
analyzing the sections of the different instruction patterns at least in terms of their execution time, in order to provide the runtime property based on the analyzed sections of the detected data.

One advantage of profiling the runtime by means of the analyzed sections can be that an understanding of the performance of the target device is gained, such that the performance of the software program executed on the target device can then be predicted more accurately. The different instruction patterns can be operation code sequences, in particular bytecode operation code sequences.

In another example embodiment of the present invention, the profiling of the software program comprises providing a series of at least two different inputs, in order to ensure that at least two different paths of the software program are exercised comprehensively. It is also possible that a plurality of different inputs are provided, wherein a higher selection of inputs can advantageously lead to a more comprehensive profiling of the software program.

According to an example embodiment of the present invention, it can also be advantageous if at least two software programs and/or the runtime of at least two target devices are profiled, and the performance is predicted based on the execution property of the at least two software programs and/or the runtime property of the at least two target devices, in order to, in each case, provide a performance prediction as a function of the at least two software programs and/or the runtimes of the at least two target devices. The performance prediction as a function can be a matrix that can comprise execution properties of a plurality of software programs and runtime properties of a plurality of target devices, such that the performance with respect to individual pairings of software programs and target devices can advantageously be accurately predicted.

In another aspect of the present invention, a computer program, in particular a computer program product, can be provided, comprising instructions that, when the computer program is executed by a computer, cause the computer to perform the method according to the present invention. Thus, the computer program according to the present invention can have the same advantages as described in detail with respect to a method according to the invention.

In another aspect of the present invention, a data processing apparatus that is designed to perform the method according to the present invention can be provided. The apparatus can, for example, be a computer that executes the computer program according to the invention. The computer can have at least one processor that can be used to execute the computer program. A non-volatile data memory can also be provided, in which the computer program can be stored and from which the computer program can be read by the processor in order to be executed.

According to another aspect of the present invention, a computer-readable storage medium can be provided, which comprises the computer program according to the invention and/or instructions that, when executed by a computer, cause the computer to execute the steps of the method according to the present invention. The storage medium can be designed as a data storage device, for example as a hard disk and/or as a non-volatile memory and/or as a memory card and/or as a solid-state drive. The storage medium can be integrated into the computer, for example.

Furthermore, the method according to the present invention can be implemented as a computer-implemented method.

Further advantages, features and details of the present invention are apparent from the following description, in which exemplary embodiments of the present invention are described in detail with reference to the figures. The features specified in this disclosure can be essential to the present invention in each case either individually or in any combination.

### BRIEF DESCRIPTION OF THE DRAWINGS

FIG. 1 shows a method, a computer program, a storage medium and an apparatus according to example embodiments of the present invention,

FIG. 2 shows a method according to example embodiments of the present invention.

### DETAILED DESCRIPTION OF EXAMPLE EMBODIMENTS

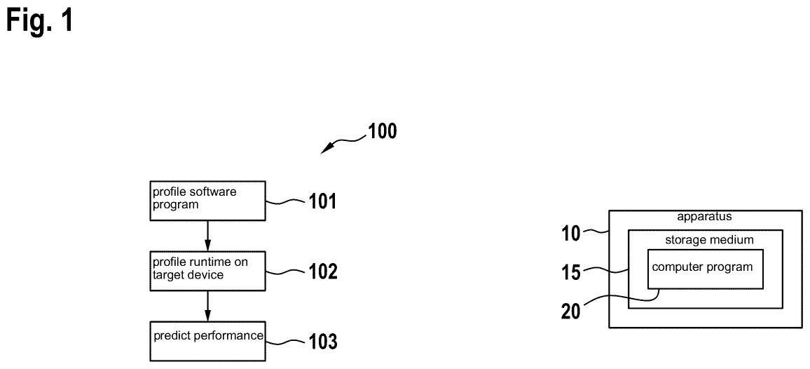

FIG. 1 shows a schematic representation of a method 100, a computer program 20, a storage medium 15 and an apparatus 10 according to embodiments of the present invention.

The method 100 according to one embodiment of the invention can comprise a first step 101, in which the software program 1 is profiled, wherein the software program 1 is provided as a bytecode representation 2, in order to provide an execution property of the software program 1. The profiling can be performed while the software program 1 is being executed. In a second step 102, a runtime on a target device 4 can be profiled in order to provide a runtime property of the target device 4. The profiling can be performed while at least one test program 5 is executed on the runtime of the target device 4. In a third step, the performance of an execution of the software program 1 on the target device 4 can be predicted based on the execution property of the software program 1 and the runtime property of the target device 4.

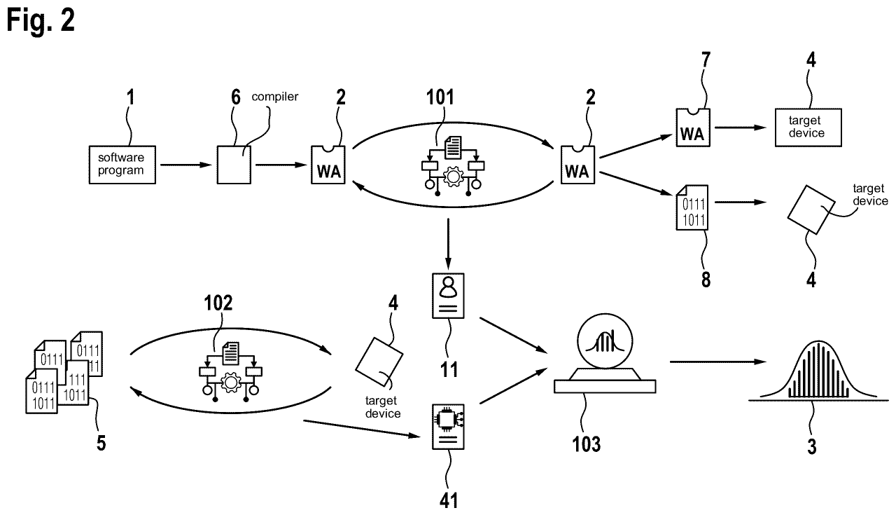

FIG. 2 shows a method according to embodiments of the invention in more detail.

In particular, the invention addresses the problem of predicting the performance of a software program 1 if it is moved from one platform to another.

In particular, as an alternative to using source code, binary or dynamic profiling measurements to predict performance, it is proposed to profile a bytecode program in an interpreted environment with extensive instrumentation, and then use these measurements to predict how well a compiled version of the software program 1 will be executed when provided. The interpreted environment can use a common intermediate instruction set between all programs 1, as a result of which a “narrow waist” for interoperability of the algorithm is provided. By selecting a simplified bytecode representation 2, for example with a reduced instruction set and without garbage collection, the method according to the invention can be particularly favorable for runtime prediction. Then this intermediate instruction set program can be compiled by Ahead-of-Time (AoT) 8 or Just-in-Time (JIT) 7 compilation on the target device 4 for deployment.

One finding of the invention can be that, while it is difficult to predict the performance of a large, complex program, it is much easier to predict the performance of fine-grained sequences of virtual instructions. By profiling a software program 1 in interpreted mode, a distribution of fine-grained virtual instruction sequences can be accurately created. Since virtual instructions can be used, the profiling can also be performed on a CPU that is much faster than the CPU on which the program is provided. In this way, it can work on a data stream in real time, although it involves additional effort for interpreted operations and extensive instrumentation. Finally, the compiled version can be executed on a much slower, resource-constrained platform with similar performance but much better energy efficiency, more flexible placement, or other favorable system properties.

The setup can comprise the software program 1 whose performance needs to be predicted, a compiler 6 that can convert the program into a bytecode or intermediate representation 2, and a “runtime,” i.e. a virtual execution environment that executes the bytecode in an interpreted mode. Note that the bytecode generated can be independent of the underlying machine instruction set architecture. The performance prediction approach according to one embodiment shown in FIG. 1 can comprise five main steps:

In a first step, the program can be compiled by a compiler 6 into a bytecode representation 2, for example WebAssembly. In a second step, the program can be profiled 101 in interpreted mode, in particular by executing the bytecode instructions one after the other using a simulated CPU in the software. The profiling setup can also ensure that the different paths of the program are exercised comprehensively by feeding in a series of inputs. The profiling step 101 can generate a distribution of the frequency of bytecode instructions and memory accesses. In a third step, the runtime can be profiled 102 on a platform of the target device 4 with many test programs 5, which cover the range of possible programs that may be relevant. In a fourth step, the bytecode can be compiled as an advance compilation (AOT) 8 in order to be executed on the target device 4. In a fifth step, the performance can be predicted 103 using features such as opcode sequences and frequency from the program profile, i.e., the execution property 11, with the runtime properties 41 of the runtime of the target device 4 for providing the forecasted performance 3.

The above approach can comprise generating an application bytecode profile, i.e., an execution property 11 of the software program 1 and a runtime target profile, and can assume that the bytecode is executed on the target device 4 via advance (AOT) 8 or just-in-time (JIT) 7 compilation. These steps are described in more detail below.

The interpreted program profiling of step 2 is explained in more detail below. Bytecode programs can be executed in a software interpreter, in which exact instruction patterns and loop passes can be precisely measured. If this bytecode is then compiled into a standalone binary file on a target device 4, many of these properties from the interpreted profiling may still apply, even though the underlying instruction set architecture of the target device 4 could be significantly different. Since the final target binary file has virtual machine elements that still function in a similar way to the interpreted version, this can increase the accuracy of the prediction problem. This step can generate a distribution of bytecode opcodes with estimated execution frequency along with similar statistics for memory access.

The target runtime profiling (virtual execution environment) of step 3 is described in more detail in the following: It may be possible to independently create a profile of the runtime execution environment for a particular target, wherein the goal is to perform a short sequence of bytecode operations and predict their performance on a particular target device 4 after they have been compiled into a native binary file. This can require the instrumentation of a runtime and then benchmarking of many test programs 5 in order to learn how the runtime of that particular target device 4 responds to short sequences of compiled bytecode. This process can be automated and repeated for each target device 4, which results in a target environment distribution of bytecode sequences and predicted performance metrics 3.

The performance prediction of step 5 is explained in more detail in the following: The final performance prediction 3 can be a function of the application profile distributions and the target performance distributions. This can be achieved in various ways using conventional approaches to performance prediction.

A simple approach could be to sum the expected value of application instruction sequences with the closest sequences that are present in the target distribution. More sophisticated approaches can also be used. It can be argued that performance prediction, even if normalized to processor speed and program length, is likely to be less of a problem. Processors that are effective for one function are also likely to be effective for similar functions (for example, floating point addition and multiplication). In addition, programs that use one function can probably use similar functions. Thus, a program runtime on each device can be organized in a program-device matrix, which could enable the runtime prediction problem to be formulated as a well-studied matrix completion problem. With matrix completion, a subset of entries in a matrix can be observed and an attempt can be made to predict the remaining entries. Combining all programs and devices into a single matrix completion problem can maximize potential data efficiency. At the same time, the matrix completion formulation can enable improved prediction for one program or device by collecting data for many other programs or devices, as a result of which the technical effort required to add additional instruments or build more sophisticated analysis tools with more data is saved. The matrix completion problem can then be solved using a matrix factorization approach based on a neural network.

This approach can be applied conceptually to any number of bytecode-based virtual execution environments, such as Java, WebAssembly, LUA, Python, etc. WebAssembly may be preferable, since it supports many different programming languages along with interpreted AoT and JIT operating modes. The execution semantics of WebAssembly can be formally defined to eliminate non-deterministic execution and make this process even more effective.

The above explanation of the embodiments describes the present invention with reference to examples. Of course, individual features of the exemplary embodiments can be freely combined with one another, provided this is technically expedient, without leaving the scope of the present invention.

What is claimed is:

1. A method for predicting performance of a software program, comprising the following steps:
profiling the software program, wherein the software program is provided as a bytecode representation, wherein the profiling is performed during execution of the software program, in order to provide an execution property of the software program;
profiling a runtime on a target device, wherein the profiling is performed while executing at least one test program on the runtime of the target device, in order to provide a runtime property of the target device;
predicting the performance of an execution of the software program on the target device based on the execution property of the software program and the runtime property of the target device.

2. The method according to claim 1, further comprising at least one of the following steps:
compiling the software program into the bytecode representation;
compiling the bytecode representation as a pre-compilation, in order to make the bytecode representation executable on the target device.

3. The method according to claim 2, wherein the bytecode representation includes at least one bytecode instruction and the profiling of the software program further includes the following step:
executing the at least one bytecode instruction at a point in time in order to analyze and describe the bytecode representation at least in terms of a frequency of the at least one bytecode instruction and a pattern of memory accesses of the at least one bytecode instruction, in order to provide the execution property of the software program,
wherein the analyzing and describing of the bytecode representation are performed based on bytecode operation code sequences of the at least one bytecode instruction, wherein an estimated execution frequency and an estimated pattern of memory accesses are provided for each bytecode operation code sequence.

4. The method according to claim 1, wherein the prediction of the performance includes a prediction of at least one of the following:
an execution time of the execution of the software program on the target device,
an energy consumption of the execution of the software program on the target device,
a memory usage of the execution of the software program on the target device,
a network usage of the execution of the software program on the target device.

5. The method according to claim 1, wherein the profiling of the runtime on the target device includes the following steps:
detecting data about the execution of the at least one test program during its execution, wherein the data include sections of different instruction patterns of the at least one test program,
analyzing the sections of the different instruction patterns at least in terms of their execution time, in order to provide the runtime property based on the analyzed sections of the detected data.

6. The method according to claim 1, wherein the profiling of the software program includes providing a range of at least two different inputs, in order to ensure that at least two different paths of the software program re exercised comprehensively.

7. The method according to claim 1, wherein at least two software programs and/or a runtime of at least two target devices are profiled, wherein the performance is predicted based on an execution property of the at least two software programs and/or a runtime property of the at least two target devices, in order to, in each case, provide the performance prediction as a function of the at least two software programs and/or the runtimes of the at least two target devices.

8. A data processing apparatus configured to predict performance of a software program, the data processing apparatus configured to:
profile the software program, wherein the software program is provided as a bytecode representation, wherein the profiling is performed during execution of the software program, in order to provide an execution property of the software program;
profile a runtime on a target device, wherein the profiling is performed while executing at least one test program on the runtime of the target device, in order to provide a runtime property of the target device;
predict the performance of an execution of the software program on the target device based on the execution property of the software program and the runtime property of the target device.

9. A non-transitory computer-readable storage medium on which are stored instructions for predicting performance of a software program, the instructions, when executed by a computer, causing the computer to perform the following steps:
profiling the software program, wherein the software program is provided as a bytecode representation, wherein the profiling is performed during execution of the software program, in order to provide an execution property of the software program;
profiling a runtime on a target device, wherein the profiling is performed while executing at least one test program on the runtime of the target device, in order to provide a runtime property of the target device;
predicting the performance of an execution of the software program on the target device based on the execution property of the software program and the runtime property of the target device.
